(19) United States
(12) Patent Application Publication
(10) Pub. No.: US 2010/0049618 A1
(43) Pub. Date: Feb. 25, 2010

(54) Services Referral System And Method

(76) Inventor: Janet Smith, Jupiter, FL (US)

Correspondence Address: MCHALE & SLAVIN, P.A., 2855 PGA BLVD, PALM BEACH GARDENS, FL, 33410, US

(21) Appl. No.: 12/195,072

(22) Filed: Aug. 20, 2008

(51) Int. Cl. G06Q 30/00; G06Q 50/00

(52) U.S. Cl. 705/26

(57) ABSTRACT

A method and system for providing a referral service for services performed by professionals and/or service providers. The referral service enables an individual or consumer to quickly and accurately determine which professional or service provider is qualified and willing to perform a specific task or provide a specific service that the individual or consumer is in need of. The referral service also determines the qualifications of the professional or service provider to perform specific tasks or provide specific services. The referral service establishes and maintains a current rating system of the professional or service provider's performance relating to specific tasks or services which they have provided to individuals or consumers.

### FIELD OF THE INVENTION

The present invention relates to the selection of professionals to perform required services in their specific fields. More specifically, the present invention relates to a method and system for the selection of qualified professionals to perform services relating to a house, home or homeowner.

### BACKGROUND OF THE INVENTION

One of the challenges that have faced individuals who need the services of professional individuals is finding the professional or company that is most qualified to perform the work and is willing to perform it at competitive prices. For example, an individual who needs the service of an attorney or law firm must actively seek out counsel and information regarding their qualifications, experience, ability to provide the specific services which are required and the fees they will charge to perform the services. Another example are individuals who are in the need of home repairs, home improvements or other services.

Homeowners and other persons responsible for the upkeep and maintenance of houses or homes, such as property caretakers and community managers who oversee landscaping, hotels, docks, golf courses, irrigation, security, etc. of a community have encountered problems finding reliable individuals and companies to perform services related to the upkeep and maintenance of properties and homes. These home owners or property managers must seek out one or more individuals or contractors to perform the services which are required. Normally an individual resorts to listings in the telephone book or advertisements to find the professionals they need. This is very time consuming and there is no way of determining the reputation or reliability of the professional or company that will perform the required service. The individual is normally overwhelmed by the many choices and apprehensive by the horror stories of corrupt contractors and repair persons on the nightly news and in newspapers.

Many people have determined that the best individual or company to perform a job or task can be found by recommendation or referrals from a friend or neighbor. This “word of mouth” type of recommendation is what most individuals rely on to hire an individual or company to perform a job or task. However, if a person is new to a community or only resides in the community for a portion of the year, this type of solution is not practical. Also people are people, sometimes people refer businesses that they truly don't know enough about the business or company unintentionally causing harm to others. In addition, if a property manager is responsible for properties that are located a distance from where they live they will not be familiar with the professionals in the area of the property needing the services that are qualified, reliable and willing to work at competitive prices. Although the Internet has provided access to professionals and companies outside of an individual's residential area this still does not provide an indication of the qualifications, reliability or willingness of the professional or company to perform the required services.

### DESCRIPTION OF THE PRIOR ART

U.S. Pat. No. 6,950,801 disclosed a method and apparatus for coordinating or arranging services, such as automotive glass repair services for the policyholders of an insurance company. The method includes providing a database of service providers, obtaining the service needs of a customer and selecting a number of service providers in the database based on the service need requirements. The database also includes a ranking of the service providers based on the customer's responses.

U.S. Published Patent Application 2004/0199412 discloses an Internet scheduling system and method which is consumer driven for effectively matching a consumer with a specific service or service provider. The selection criteria of the service or service provider include the geographical area with respect to the consumer, price information, service provider experience, education background and other information. Consumers provide information such as e-mail addresses, telephone numbers, addresses, and health insurance plans. Service providers can give special recommendations or critiques following their service for future consumer reference.

What is needed in the art is a referral service and device for providing services to consumers or individuals who are not familiar with the local area or local service providers and cannot rely on other individuals for a recommendation.

### SUMMARY OF THE INVENTION

A method and system for providing a referral service for services performed by professionals and/or service providers. The referral service enables an individual or consumer to quickly and accurately determine which professional or service provider is qualified and willing to perform a specific task or provide a specific service that the individual or consumer is in need of. The referral service also determines the qualifications of the professional or service provider to perform specific tasks or provide specific services. The referral service establishes and maintains a current rating system of the professional or service provider's performance relating to specific tasks or services which they have provided to individuals or consumers.

Accordingly, it is an objective of the instant invention to provide a referral service and method for providing individuals with information relating to the qualifications and performance of professional and/or professional services to perform specific jobs or tasks.

It is a further objective of the instant invention to provide a referral service and method which includes a database of qualified professionals or professional services that have been pre-screened to determine their qualifications and reliability.

It is yet another objective of the instant invention to provide a referral service and method which permits the individual or consumer to provide feedback to the referral service of the quality of the service or services performed.

It is a still further objective of the invention to provide a referral service and method which permits the professional or professional service to respond to negative criticism from an individual or consumer.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an schematic illustration of the system which operates the referral service of the instant invention;

FIG. 2 is a flow chart of the process of the referral service of the present invention and

FIG. 3 is a continuation of the flow chart in FIG. 2.

### DETAILED DESCRIPTION OF THE INVENTION

The detailed description set forth herein after is a presently preferred embodiment of the instant invention. It is not intended to be the only form in which the instant invention may be constructed or utilized. The following description sets forth the sequence of steps, functions and devices for performing and operating the instant invention. It is to be understood that the same or equivalent functions and sequences of steps may be accomplished by different embodiments and devices and they are intended to be encompassed within the scope of the instant invention.

It is believed that the methods and devices of the instant invention can encompass virtually every type of service capable of being rendered. For example, but not limited to, home repair services, home improvement services, construction services, automotive services, marine services, legal services, accounting, voluntary services, personal services, physician services, dental services, etc. Theses services may be related to particular professionals or trades such as plumbing, electricians, carpenters, masonry workers, landscapers, automobile service, computer networking, physicians, dentists, hair stylists, etc.

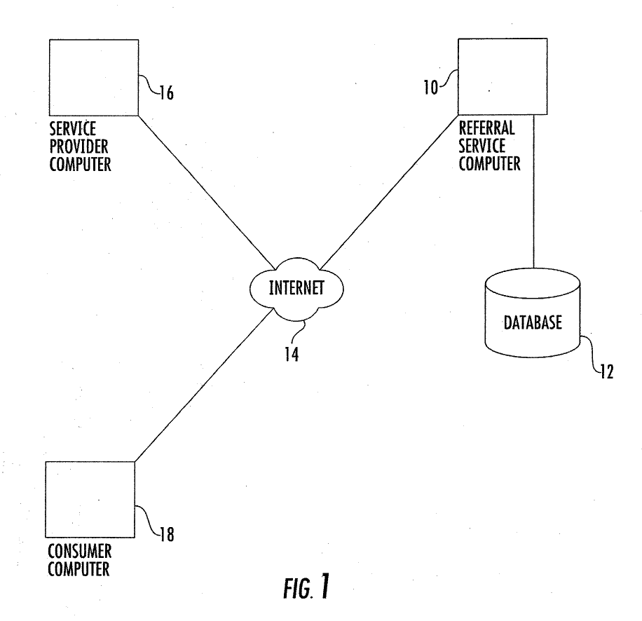

Referring to FIG. 1 there is depicted a system or device for performing the on-line referral service of the instant invention. In this regard the instant invention is directed to a novel and unique method for enabling an individual or consumer to evaluate and obtain services from qualified and recommended service providers. These services are based on criteria provided by a consumer and qualifications of the service provider. The criteria can include specifications and parameters pertinent to the task or service required. These criteria include a description of the nature of the task or problem, the geographic location of the task or service, the time frame in which the services are required, and any other pertinent information. These services and service providers are posted on a website maintained by a referral service. The individuals or consumers need only to enter or post on the website the particulars of the services that they are in need of. The website will provide to the consumer the service provider's qualifications, and ability to schedule the service or tasks. With this information the individual or consumer can compare the different service providers at their leisure in the comfort of their home or place of business.

In FIG. 1 the referral service includes at least one computer 10 which operates the referral service and provides a website for consumers and service providers to access through the Internet 14. The referral service includes a database 12 which included information regarding the service providers, the services they can provide, their qualifications, their recommendations, and other information necessary for a consumer to select the best professional and/or service provider to perform the service or task required by the consumer. The database 12 also includes information relating to the consumer. The professional or service provider submits their information to the referral service from their at least one computer 16 over the Internet 14. This information is stored in the database 12. The individual or consumer submits their requests and/or other information from at least one computer 18. The consumer will also receive information regarding the professional or service provider from the referrals service 10 over the Internet 14 at their computer 18. The consumer may then contact the service provider via the Internet or any other means such a telephone, a FAX, by mail or in person.

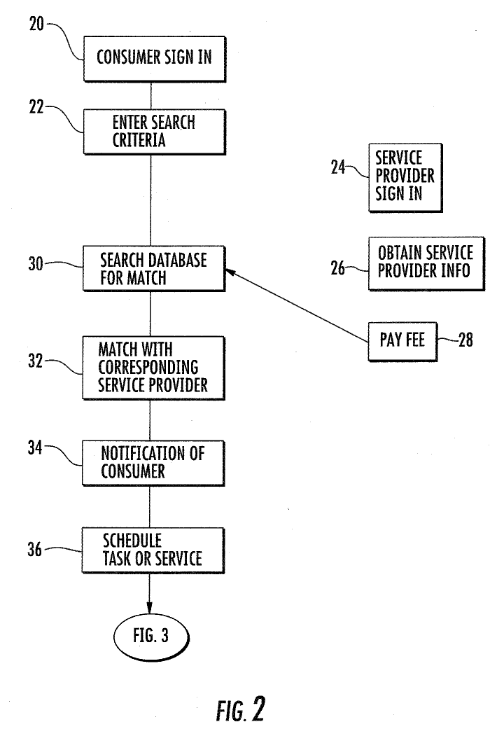

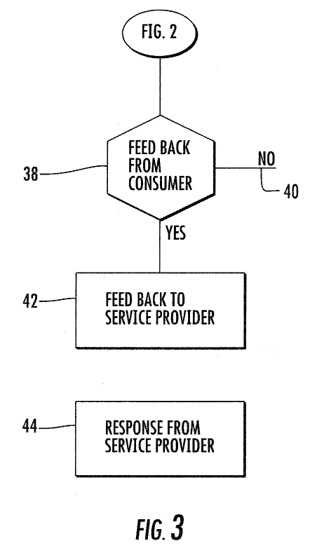

Referring to FIGS. 2 and 3 the method of obtaining the services required by an individual or consumer is demonstrated. In FIG. 2 at 20 a consumer accesses or signs in to a website of a referral service 10. The consumer enters the criteria of a task or service required at 22. This information is provided to the database 12. A professional or service provider signs into the system at 24. The professional or service provider then enters their information into the system at 26. The professional or service provider may then pay a fee to be included in the referral system at 28. This information is then entered into the database 12. The database 12 is then searched for a match between the criteria of the task of the consumer and the qualifications of the service provider at 30. A match between the consumer's criteria and the service provider's qualifications is then performed at 32. The consumer is then notified, at their computer 18, of the match between their criteria and one or more service providers at 34. After the consumer has selected a service provider the task or service to be provided is scheduled at 36. This scheduling can be performed over the Internet at the referral website, over the Internet at the service provider's website, by telephone, via FAX, by mail, in person, etc.

Now referring to FIG. 3, after the task or service has been performed the consumer may provide feedback regarding the task or service to the referral service at 38. If there is no feedback from the consumer the process ends at 40. The feedback is provided to the professional or service provider at 42. The professional or service provider can then respond to the feedback at 44.

Many individuals or consumers do not have the ability or time to check a professional or service provider's qualifications. They are wary of unlicensed and unscrupulous professionals, service providers and other individuals that hold themselves out as licensed and reliable. The referral service screens the professionals and service providers for the consumer. The referral service checks at least ten references that the professional or service provider has provided to the referral service. The referral service also checks the licenses and/or certifications of the professional or service provider. The term license is to be defined or construed to include any type of third party approval or authorization that an individual is qualified to perform a specific task or tasks and/or provide a specific service or services. The referral service checks to see it the professional has current and adequate insurance. The referral service also checks with the Better Business Bureau for complaints and complements regarding the professional or service provider. The referral service checks the corporate registration of the service provider with the state. They check to see how many companies or entities the owner of the service provider has opened and closed. Certain companies will close a business if there are too many complaints against them. They will then open another company and start over. Most individuals or consumers cannot or do not have the knowledge or ability to perform this check. The referral service will also check the Attorney General's office to determine if there are any complaints against the professional or service provider. They will also check to see how there complaints have been resolved. Finally, the service provider will check any other sources to determine the qualifications and reputation of the professional or service provider.

The referral service provides and maintains an ongoing evaluation of the quality of work, qualifications and level of professionalism of the professionals and service providers. Some of the professionals and service providers include in the areas of home improvement, maintenance and repair: air conditioning, heating, air filtration services, appliance repair services, residential architectural designers, architects, outdoor art, cabinet makers, custom woodworking, fine carpentry, closet organizers, closet designers, closet systems, decks, patios, walkway design and construction, custom doors and windows, electricians, exterior restoration, fencers, gate design and constructions, fireplaces design and construction, flooring contractors, flooring maintenance, residential custom garage doors, general contractors, home improvement contractors, handymen, home repair men, pest and insect removal, asphalt paving, custom home theaters, smart home technology, hurricane protection, interior design and decorating, irrigation systems, kitchen and bath remodeling and design, landscape design and construction, lawn and garden maintenance services, leak detection services, mold detection and remediation services, landscape lighting, interior home lighting, residential locksmith services, house cleaning services, outdoor kitchens and living, painters, mural painters, plumbers, pools and spas design and construction, pool cleaning and maintenance, pressure cleaning and sealing, ADA approved ramp access, roofers and roofing contractors, custom pool and patio enclosures, home security systems, home inspectors, residential railing systems, shower glass installation and repair, sunrooms, tile installers and finishers, arborist and tree cutting services, interior wall and drywall contractors, residential water filtration systems, and window treatments. Some other professionals and service providers include in the area of auto services: auto repair service, foreign auto repair service, dent removal service, collision service, car wash, auto detailing service, windshield repair, window tinting, convertible tops, auto parts and accessories, auto sound systems, auto communications and security services, upholstery, auto restoration, welding, auto parts for classic cars, auto and motorcycle chrome installation and service, auto books, manuals, posters, videos, racing schools and tracks. Some other professionals and service providers include in the area of marine services: marine construction, dock installation, dock preservation, sealing and repair, seawal installation and repair, boat lifts, jet ski lifts, davits, pilings, rock revetments, sundecks, gazebos, benches, golf course bridges, golf course retaining walls, walkways and dune walkovers, ladders, railings, rope handrails, cleats and bumpers, copper and plastic piling caps, erosion control and repairs, lift maintenance, mangrove trimming with permits, inspections for buyers and sellers, boat restoration, boat upholstery and window treatments, boat window repairs, gauges and trim chrome, boat accessories, boat appliances, boat engine repair, boat electrical services, boat plumbing services, fishing accessories, fishing services, captain and crew rentals, boat rentals, sail makers, canvas tops, and sailing and coast guard schools. Some other professionals and service providers include: obstetrics, gynecologists, dentists, cosmetic dentistry, children's dentists, orthodontist, pediatrician, orthotics, physical therapists, oncologist, internal medicine specialist, orthopedist, dermatologist, plastic surgeon, veterinarians, accountants, psychiatrist, psychologist, nutritionist, resume builder, life coach, photographers, portrait artists, tutors, Web designers, editors, graphic artist, piano teacher, voice coach, sports coaches, tennis professionals, golf professionals, financial planners, ministers (for weddings, baptisms, funerals, etc.), computer and network services, audio-visual services, sommeliers, piano tuners, chefs and attorneys. Some other professionals and service providers include in the area of personal services include: manicurist, pedicurist, hair colorist, hair stylist, hair removal, masseuse, make-up artist, personal shopper, shoe repair, shoes, best kids shoes, tailor, wedding dresses, wedding planner, party planner, caterer, bartender, bands, valets (for personal or business parties), limousines, butlers, housekeepers, house managers, concierge, caretakers, personal assistant, chauffer, nanny, babysitter, pre-pared meals, churches, schools, Sunday schools, summer camps, country clubs, furniture repairs, antique restoration, florist, fitness trainer, Pilates instructor, yoga instructor, dance instructor, framers, dog walkers, disaster preparation, disaster cleanup, pet groomers, kennels, book binders, dry cleaners and horse trainers.

The referral service also includes and maintains a certification of the professional or service provider. This certification includes the following. The service provider's corporation. Is it an active corporation licensed to conduct business in the state in which the services are rendered? The referral service checks to see if the service provider is an officer in numerous corporations, if so the service provider will demonstrate why, particularly if there are numerous name changes. The officers must explain reasons for their affiliation with inactive corporations. If the officer is affiliated with other active corporations the officer will explain the reasons for their affiliation.

The service provider's license is verified so that they can conduct business in a particular state in which the services are to be rendered and for the specific services. If there are any discrepancies such as work category, license name, company name, address, license status, the service provider will explain these to the satisfaction of the referral service. The service will provide additional information if the license is less that five (5) years old. The service provider will also explain any and all complaints listed under the license to the satisfaction of the referral service.

The service provider's corporation is verified under the Better Business Bureau. If the service provider's corporation is listed under the Better Business Bureau and has a grade less than “C” the service provider will explain this to the satisfaction of the referral service.

The service provider will demonstrate that they have adequate insurance, in particular worker's compensation insurance in the state in which the service are to be provided. If the service provider's insurance shows any discrepancies under the company name, address, term of coverage, of exemptions the service provider will explain these discrepancies to the satisfaction of the referral service.

The service provider will explain any Stop Work Order issued against it under the state in which the services are to be performed to the satisfaction of the referral service.

The service provider will provide at least ten (10) verifiable commercial and/or residential customer references for each category of service they provide. These references include telephone numbers and addresses which the referral provider can check.

The service provider corporation will be verified through the office of the Attorney General for the state in which the services are to be provided. The service provider will explain any and all legal complaints filed under the corporation or service provider's name to the satisfaction of the referral service.

The service provider's website will be verified by the referral service.

The service provider will be checked by the referral service for “most wanted” on the crime information center website in the state in which the services are to be provided.

The service provider will be checked by the referral service for sexual offenders or predator sexual offenders on the website in which the services are to be provided.

The referral service includes a rating of the professionals and service providers. EBAY has stars to rate its users. The referral service preferably employs hammers to rate the professional and service providers. Although hammers are illustrated any other type icon or rating can be employed. To obtain an initial rating the professional or service provider will provide a list of at least ten (10) references. The professional or service will meet all of the criteria established in the certification listed above. The date ranges covered by the license and insurance are verified. The website of the professional or service provider is checked to verify the license number and contact information according to the category of service, i.e. home improvement, home repair, auto services, marine services, etc.; the service type, i.e. HVAC, electrician window and door service, fencing, etc.; geographic location, can and will the service provider travel to perform the required services.

Subsequent to obtaining an initial rating the referral service enables the consumer to provide feedback regarding the services obtained by a professional or service provider. This feedback can raise or lower the rating. The rating can be raised to a maximum and no further. The consumer is aware of what the maximum rating is. The rating can also be lowered by the consumer's negative comments. If there are negative comments the professional or service provider has a predetermined period of time, for example 3 days to rectify the situation with the consumer. If the problem is not resolved the professional or service provider's rating can be lowered. The professional or service provider can also respond to the referral service regarding negative comments to prevent unwarranted comments from being held against them. For example illness or jury duty may prevent the professional or service provider from performing the service within the time frame set in the contract.

Should a professional or service provider's rating drop to a predetermined level they are placed on probation and the referral service will determine a proper course of action. This course of action may include the professional or service provider being dropped because they will not improve. The professional or service provider may be temporarily removed from the referral service and a plan to improve their service will be suggested by the referral service. If they improve they will be reinstated onto the referral service. If there are inappropriate and unjustified negative comments against the professional or service provider the referral service will remove these and reinstate the professional or service provider's rating.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method for soliciting services to be provided by a service provider relative to a task required by an individual over at least one computer network wherein said the network connects at least one computer associated with said individual to at least one information providing computer comprising the steps:
1) said individual providing criteria regarding the service to be provided;
2) providing said criteria to a database of known service providers;
3) identifying and selecting a group of service providers in said database which have the ability to provide a service relative to a task specified in said criteria;
4) determining the qualifications of said group of service providers;
5) generating at least one response from said service providers relative to said task;
6) forwarding said at least one response from said at least one service provider to said individual.

2. The method of claim 1 wherein said criteria includes information selected from a group consisting of the nature of said task, a geographic area in which the task is to be performed and a time frame in which said task is to be performed.

3. The method of claim 1 including the step of rating the service provided by said service provider.

4. The method of claim 1 wherein said task and said criteria are related to repair services and said service providers include licensed service providers.

5. The method of claim 1 wherein said task and said criteria are related to construction services and said service providers are licensed contractors.

6. The method of claim 1 wherein said task and said criteria are related to home improvement services and said service providers are licensed home improvement contractors.

7. The method of claims 1 wherein said task and said criteria are related to automobile services and said service providers are licensed automobile service providers.

8. The method of claim 1 wherein said task and said criteria are related to marine services and said service providers are licensed marine service providers.

9. The method of claim 1 wherein said task and said criteria are related to personal services and said service providers are licensed personal service providers.

10. A device performing a method for soliciting services to be provided by a service provider relative to a task required by an individual over at least one computer network wherein said the network connects at least one computer associated with said individual to at least one information providing computer comprising:
1) a device allowing said individual to provide criteria regarding said service to be provided;
2) a device providing said criteria to a database of known service providers;
3) a device identifying and selecting a group of service providers in said database which have the ability to provide a service relative to a task specified in said criteria;
4) a device determining the qualifications of said group of service providers;
5) a device generating at least one response from said service providers relative to said task;
6) a device forwarding said at least one response from said at least one service provider to said individual.

11. The device of claim 10 wherein said criteria includes information selected from a group consisting of the nature of said task, a geographic area in which the task is to be performed and a time frame in which said task is to be performed.

12. The device of claim 10 including a device providing a rating of the service provided by said service provider.

13. The device of claim 10 wherein said task and said criteria are related to repair services and said service providers include licensed service providers.

14. The device of claim 10 wherein said task and said criteria are related to construction services and said service providers are licensed contractors.

15. The device of claim 10 wherein said task and said criteria are related to home improvements and said service providers are licensed home improvement contractors.

16. The device of claim 10 wherein said task and said criteria are related to automobile services and said service providers are licensed automobile service providers.

17. The device of claim 10 wherein said task and said criteria are related to marine services and said service providers are licensed marine service providers.

18. The device of claim 10 wherein said task and said criteria are related to personal services and said service providers are licensed personal service providers.
